(19) United States
(12) Patent Application Publication
(10) Pub. No.: US 2007/0239682 A1
(43) Pub. Date: Oct. 11, 2007

(54) System and method for browser context based search disambiguation using a viewed content history

(76) Inventors: Paul Thomas Arellanes, Austin, TX (US); Michael Roy Camp, Glenwood, MD (US); Marzyeh Ghassemi, Beaverton, OR (US); Frank Lawrence Jania, Chapel Hill, NC (US); Juan Carlos Suarez, Chapel Hill, NC (US); Aditya Unnithan, Charlotte, NC (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/398,866

(22) Filed: Apr. 6, 2006

(51) Int. Cl. G06F 17/30

(52) U.S. Cl. 707/3

(57) ABSTRACT

A mechanism is provided for context based search disambiguation. A client provides additional cues for search term disambiguation through the context of the specific user's browser. In one embodiment, a viewed content history is sent along with the search term(s) to be disambiguated. The viewed content history acts as a cue to a clustering search engine to display as more relevant the results that are classified in the same category as the pages sent along with the search term(s).

### BACKGROUND

1. Technical Field

The present application relates generally to an improved data processing system and method. More specifically, the present application is directed to a system and method for browser context based search disambiguation using a viewed content history.

2. Description of Related Art

The Internet is a global network of computers and networks joined together by means of gateways that handle data transfer and the conversion of messages from a protocol of the sending network to a protocol used by the receiving network. On the Internet, any computer may communicate with any other computer with information traveling over the Internet through a variety of languages, also referred to as protocols. The set of protocols used on the Internet is called transmission control protocol/Internet Protocol (TCP/IP).

The Internet has revolutionized communications and commerce, as well as being a source of both information and entertainment. With respect to transferring data over the Internet, the World Wide Web environment, also referred to simply as “the Web,” is used. The Web is a mechanism used to access information over the Internet. In the Web environment, servers and clients effect data transaction using the hypertext transfer protocol (HTTP), a known protocol for handling the transfer of various data files, such as text files, graphic images, animation files, audio files, and video files.

On the Web, the information in various data files is formatted for presentation to a user by a standard page description language, the hypertext markup language (HTML). Documents using HTML are also referred to as Web pages. Web pages are connected to each other through links or hyperlinks. These links allow for a connection or link to other Web resources identified by a universal resource identifier (URI), such as a uniform resource locator (URL).

A browser is a program used to look at and interact with all of the information on the Web. A browser is able to display Web pages and to traverse links to other Web pages. Resources, such as Web pages, are retrieved by a browser, which is capable of submitting a request for the resource. This request typically includes an identifier, such as, for example, a URL. As used herein, a browser is an application used to navigate or view information or data in any distributed database, such as the Internet or the World Wide Web.

Given the amount of information available through the World Wide Web, search engines have become valuable tools for finding content that is relevant to a given user. A search engine is a software program or Web site that searches a database and gathers and reports information that contains or is related to specified terms. However, given the vast amount of information on the Internet, search results often include millions, or even tens of millions, of matching files, which are referred to as “hits.” Many of these hits may be irrelevant to the user's intended search. For example, if a user were to request a search of the term “mercury,” the results could include hits related to the element, the automobile manufacturer, the record label, the Roman god, the NASA manned spaceflight project, or some other category.

Once solution to this problem is to include more terms in the search request to disambiguate the search. In the above example, the user may refine the search to include “mercury AND car.” However, it is up to the user to determine which terms to add to refine the search.

One high tech solution is to use a clustering search engine, which groups results of the search into clusters. Examples of existing clustering search engines include the Clusty™ search engine, the KartOO search engine, the WebClust search engine, and the QKSearch search engine. “CLUSTY” is a trademark of Vivisimo, Inc. in the Unites States, other countries, or both. These search engines are metasearch engines, which send user requests to several other search engines and/or databases and return the results from each one. They allow users to enter their search criteria only one time and access several search engines simultaneously.

A cluster is a group of similar topics that are related to the original query. The clusters are presented to the user through folders. The aim of this search engine technique is to organize numerous search results into several meaningful categories (clusters). The user gets an overview of the available themes or topics. Via one or two clicks on a folder and/or subfolders, the user may arrive at relevant search results that would be too far down in the ranking of a traditional search engine. In addition, the user may view similar results together in folders rather than scattered throughout a seemingly arbitrary list. For more detailed description of clustering search engines, see for example U.S. Pat. No. 6,119,124 to Broder et al., entitled “Method for Clustering Closely Resembling Data Objects,” issued Sep. 12, 2000; and, U.S. Pat. No. 6,167,397 to Jacobson et al., entitled “Method of Clustering Electronic Documents in Response to a Search Query,” issued Dec. 26, 2000.

While clustering search engines organize results into categories, these categories are naïve of the intention of the user. Given only a search query, no one category can be given a higher relevancy than any other. In addition, the algorithm used by a typical clustering engine produces human readable category names that may often be ambiguous themselves.

### SUMMARY

The illustrative embodiments recognize the disadvantages of the prior art and provide mechanisms for context based search disambiguation using a viewed content history. A client provides additional cues for search term disambiguation through the context of the specific user's browser. In one embodiment, a viewed content history is sent along with the search term(s) to be disambiguated. The viewed content history acts as a cue to a clustering search engine to display as more relevant the results that are classified in the same category as the pages sent along with the search term(s).

In one illustrative embodiment, a computer program product comprising a computer usable medium having a computer readable program is provided. The computer readable program, when executed on a computing device, causes the computing device to receive a search query from a requesting user and perform a search to obtain a search result set comprising a plurality of data elements that satisfy the search query. The computer readable program may further causes the computing device to classify the search result set to generate a clustered result set, wherein the clustered result set comprises the plurality of data elements clustered into a plurality of categories. The computer readable program may causes the computing device to classify a viewed content history into the plurality of categories and rank the clustered result set according to the classification of the viewed content history to form a ranked cluster result set.

The computer readable program may further cause the computing device to return the ranked cluster result set to the requesting user. In one exemplary embodiment the ranked cluster result set is returned to the requesting user as a structured document.

In an illustrative embodiment, the computer readable program may cause the computing device to present the ranked cluster result set to the requesting user in descending order of the number of data elements from the viewed content history that fit into each of the plurality of categories. In another illustrative embodiment, the viewed content history comprises a currently viewed data element. In yet another embodiment, the viewed content history comprises at least a portion of a browser history.

In another illustrative embodiment, an apparatus is provided that comprises a processor and a memory coupled to the processor. The memory may contain instructions which, when executed by the processor, cause the processor to execute a clustering search engine. The instructions may comprise a search component configured to receive a search query from a requesting client device and to perform a search to obtain a search result set comprising a plurality of data elements that satisfy the search query. The instructions may further comprise a clustering component configured to classify the search result set to generate a clustered result set, wherein the clustered result set comprises the plurality of data elements clustered into a plurality of categories. The clustering component may further be configured to classify a viewed content history into the plurality of categories and to rank the clustered result set according to the classification of the viewed content history to form a ranked cluster result set.

In a further illustrative embodiment, the memory may contain instructions which, when executed by the processor, cause the processor to perform one or more of the operations described above with regard to the computer readable program.

In another illustrative embodiment, an apparatus is provided that comprises a processor and a memory coupled to the processor. The memory may contain instructions which, when executed by the processor, cause the processor to execute client-side search disambiguation component. The instructions may comprise a disambiguation component configured to receive a clustered result set comprising a plurality of data elements that satisfy a search query, wherein the clustered result set comprises the plurality of data elements clustered into a plurality of categories. The instructions may further comprise a clustering component configured to classify a viewed content history into the plurality of categories and to rank the clustered result set according to the classification of the viewed content history to form a ranked cluster result set.

In a further illustrative embodiment, the memory may contain instructions which, when executed by the processor, cause the processor to perform one or more of the operations described above with regard to the computer readable program.

In a further illustrative embodiment, a method, in a data processing system, is provided for search disambiguation. The method may comprise one or more of the operations described above with regard to the computer readable program.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which exemplary aspects of the illustrative embodiments may be implemented;

FIG. 2 is a block diagram of a data processing system that may be implemented as a server in accordance with an exemplary embodiment;

FIG. 3 is a block diagram illustrating a data processing system in which exemplary aspects of the illustrative embodiments are implemented;

FIG. 4 illustrates an example Web browser display in accordance with an exemplary embodiment;

FIGS. 5A and 5B are block diagrams illustrating operation of a clustering search system with server side search disambiguation in accordance with an illustrative embodiment;

FIGS. 6A and 6B are block diagrams illustrating operation of a clustering search system with client side search disambiguation in accordance with an illustrative embodiment;

FIG. 7 illustrates an example Web browser display presenting a results page in accordance with an exemplary embodiment; and

FIG. 8 is a flowchart illustrating operation of a clustering search system with search disambiguation in accordance with an exemplary embodiment.

### DETAILED DESCRIPTION OF THE PREFERRED EMBODIMENTS

The illustrative embodiments set forth herein provide mechanisms for context based search disambiguation using a viewed content history. As such, the mechanisms of the illustrative embodiments are preferably implemented in a distributed data processing environment. In the following description, the mechanisms of the illustrative embodiments will be described in terms of a distributed data processing environment in which there is a network of data processing systems provided that may communicate with one another via one or more networks and communication links.

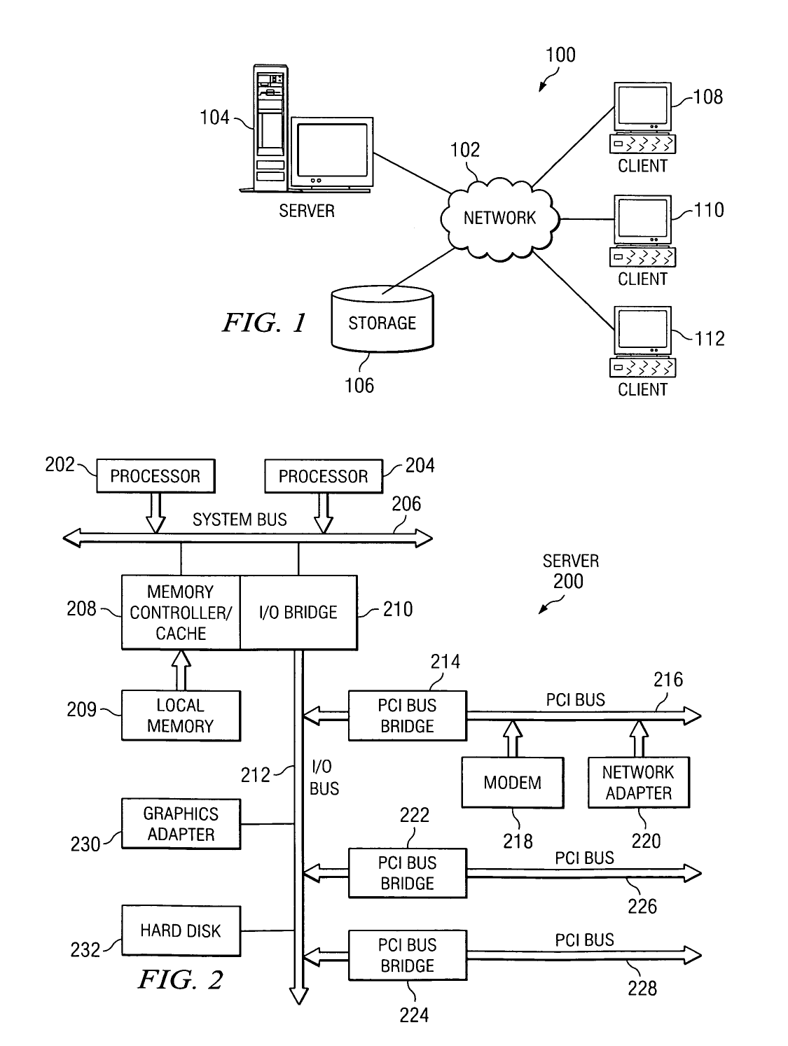

FIGS. 1-3 provide examples of data processing environments in which aspects of the illustrative embodiments may be implemented. The depicted data processing environments are only exemplary and are not intended to state or imply any limitation as to the types or configurations of data processing environments in which the exemplary aspects of the illustrative embodiments may be implemented. Many modifications may be made to the data processing environments depicted in FIGS. 1-3 without departing from the spirit and scope of the present invention.

With reference now to the figures, FIG. 1 depicts a pictorial representation of a network of data processing systems in which exemplary aspects of the illustrative embodiments may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the example shown in FIG. 1, server 104 is connected to network 102 along with storage unit 106. In addition, clients 108, 110, and 112 are connected to network 102. These clients 108, 110, and 112 may be, for example, personal computers or network computers. Server 104 may provide data, such as boot files, operating system images, and applications to clients 108-112. Clients 108, 110, and 112 are clients to server 104. Network data processing system 100 may include additional servers, clients, and other devices not shown.

More particularly, server 104 may provide a search engine to users of clients 108-112. A search engine is a software program or Web site that searches a database and gathers and reports information that contains or is related to specified terms. However, given the vast amount of information on the Internet, search results often include millions, or even tens of millions, of matching data elements, which are referred to as “hits.” In Internet or Web searches, data elements that are identified as hits may include hypertext markup language (HTML) files, images, text documents, word processing documents, spreadsheets, Usenet newsgroup posts, or any other files or other data elements that may be presented in a Web browser or other document viewer. Many of these hits may be irrelevant to the user's intended search. For example, if a user were to request a search of the term “mercury,” the results could include hits related to the element, the automobile manufacturer, the record label, the Roman god, the NASA manned spaceflight project, or some other category.

In accordance with an exemplary aspect, server 104 provides a clustering search engine. A client, such as one of clients 108-112, provides additional cues for search term disambiguation through the context of the specific user's browser. In one embodiment, a viewed content history is sent along with the search term(s) to be disambiguated. The viewed content history may be, for example, the content of a currently viewed page, the content of a number of previously viewed pages, or one or more uniform resource locators from a currently viewed page and/or previously viewed pages in the browser history. The viewed content history acts as a cue to the clustering search engine to display as more relevant the results that are classified in the same category as the pages sent along with the search term(s).

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with an exemplary embodiment. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® system, a product of International Business Machines Corporation in Armonk, N.Y., running the Advanced Interactive Executive (AIX®) operating system or Linux™ operating system. “eServer,” “pSeries,” and “AIX” are trademarks of International Business Machines Corporations in the United States, other countries, or both. “LINUX” is a trademark of Linus Torvalds in the United States, other countries, or both.

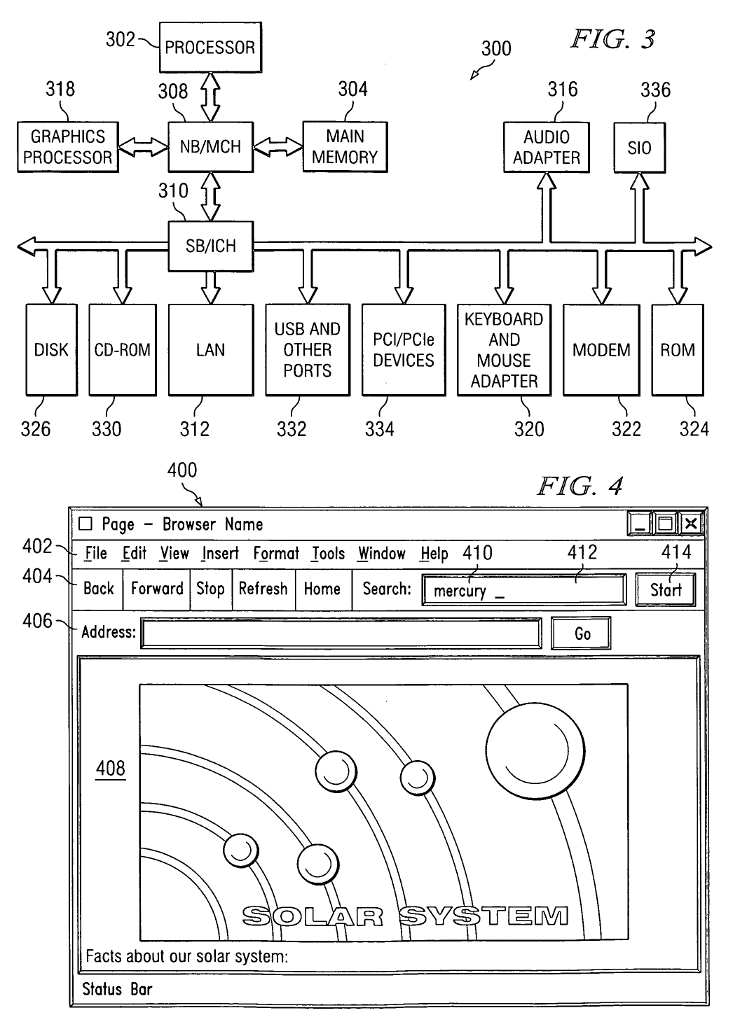

With reference now to FIG. 3, a block diagram illustrating a data processing system is depicted in which exemplary aspects of the illustrative embodiments are implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards.

In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows® XP, which is available from Microsoft Corporation. “WINDOWS” is a trademark of Microsoft Corporation in the United States, other countries, or both. An object oriented programming system such as the Java™ programming system may run in conjunction with the operating system and provide calls to the operating system from Java™ programs or applications executing on data processing system 300. “JAVA” is a trademark of Sun Microsystems, Inc. in the United States, other countries, or both. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer, hand held computer, or telephone device in addition to taking the form of a PDA. Data processing system 300 also may be a kiosk or a Web appliance.

FIG. 4 illustrates an example Web browser display in accordance with an exemplary embodiment. Browser window 400 includes menu bar 402 and several button bars, including navigation bar 404, address bar 406, and display area 408. Menu bar 402 provides command menus that allow a user to select commands using a pointing device, such as a mouse. Menu bar 402 also allows the user to select commands using key combinations on a keyboard. The commands available through menu bar 402 may also be represented by buttons on navigation bar 404, for example. Navigation bar 404 provides button controls that allow the user to issue commands for navigation among Web pages. Address bar 406 allows the user to type an explicit page identifier, such as a URL, for a page to be viewed. The current page is presented in display area 408.

In the depicted example, search tool interface 410 allows the user to perform an Internet search for Web documents relevant to a given search term or query. The user may type one or more search terms into field 412. The query may be a single word, a combination of words, or a Boolean expression. To execute the search, the user may select “Start” button 414. Search tool interface 410 may be provided as a component of the Web browser application. However, in an alternative embodiment, search tool interface 410 may be provided as an extension of the browser, i.e. a browser plug-in. Alternatively, the aspects of the exemplary embodiments described herein may also apply to searches originated using a search engine Web page or an application that is external to the Web browser.

When a search is submitted to a search engine, a message is sent to the server that hosts the search engine application. This may be done using an HTTP get request with the search query encoded in a URL. A person of ordinary skill in the art will recognize that other methods of submitting a query to the search engine may be used within the spirit and scope of the exemplary embodiments. The search engine performs the search to obtain results. Then, the search engine generates a Web page containing the results and returns the results page to the requesting client, in this case the Web browser. The results may then be presented in display area 408 of browser window 400.

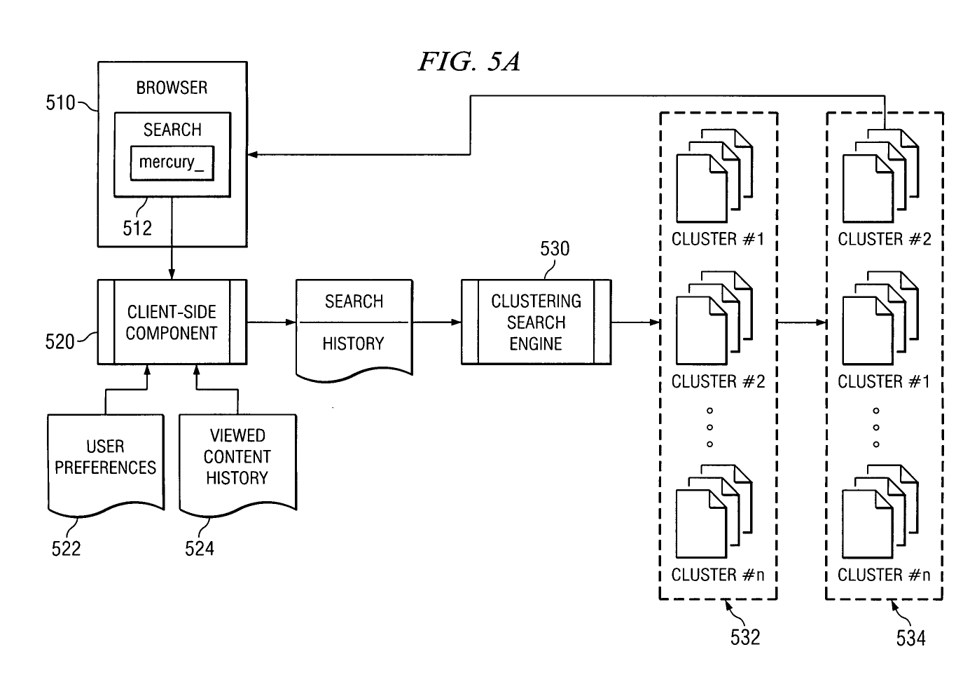

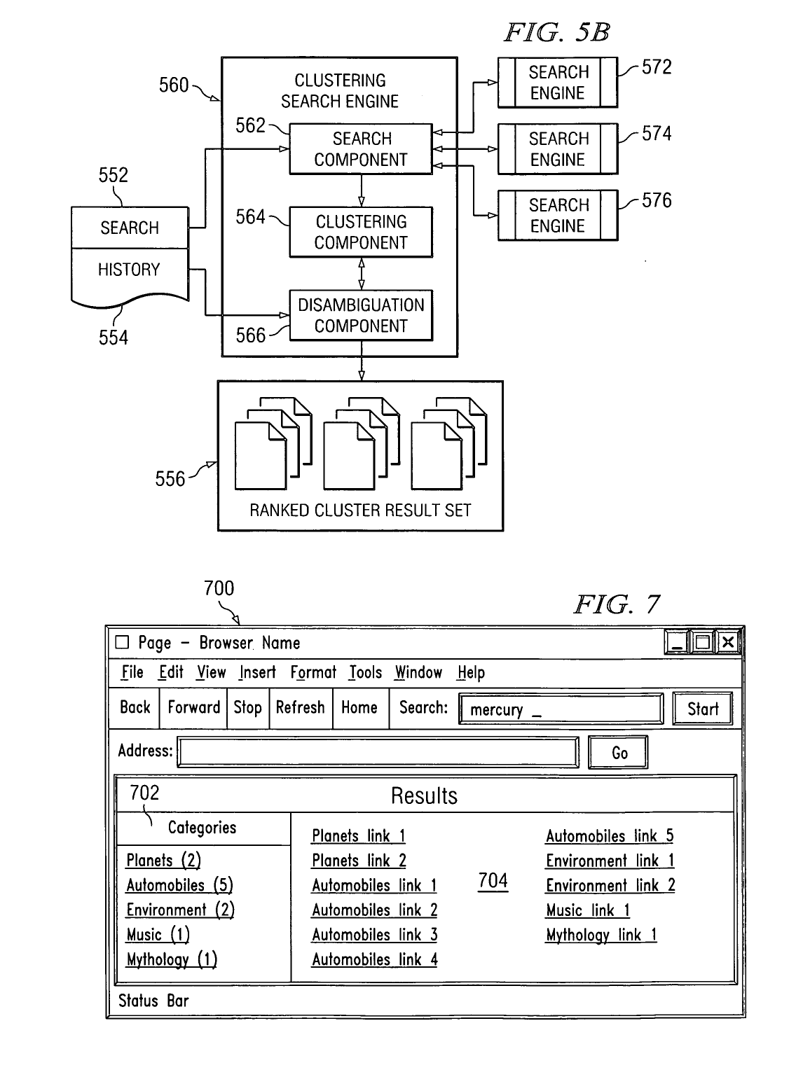

FIGS. 5A and 5B are block diagrams illustrating operation of a clustering search system with server side search disambiguation in accordance with an illustrative embodiment. With reference to FIG. 5A, at the client, browser 510 receives search query 512 from a user. Client-side component 520 may access viewed content history 524, which is maintained by browser 510. That is, most Web browser applications keep a history of viewed content, generally as a list of URLs organized by date and/or time. Often, the browser application keeps a limited amount of viewed content history information. For example, the browser may keep only the viewed content history for the last ten days; however, this may be customized by the user via a preferences or options interface. Typically, the currently viewed page is considered part of the viewed content history. These customized options of the user may be stored in user preferences 522.

In the depicted example, client-side component 520 sends the search query to clustering search engine 530, along with history information. The history information may be only the currently viewed page or possibly the entire viewed content history. Also, the history information may include the contents of viewed pages, the title information, or the URLs of the viewed pages, for example. In one exemplary embodiment, the amount of history information and/or the form of the history information to be used for search disambiguation may be set by the user and stored in user preferences 522.

In addition, client-side component 520 may apply rules to determine the amount of viewed content history to use for search disambiguation. For example, client-side component 520 may use the last ten viewed data elements unless one or more of the viewed data elements were viewed more than one day ago, in which case only the current day's viewed content history would be used.

Client-side component 520 may be a component of browser 510. In an alternative embodiment, client-side component 520 may be an extension of browser 510, i.e. a browser plug-in. Alternatively, client-side component 520 may be a software component within a search engine Web page, such as a Java™ applet or the like, or an application that is external to browser 510. For example, in one alternative embodiment, client-side component 520 is a proxy server.

Clustering search engine 530 receives the search query and history information and performs the search to obtain a search result set. Clustering search engine 530 may conduct the search using known search tools techniques, such as directory listings, Web crawling, and PageRank™ to name a few. “PageRank” is a trademark of Google in the United States, other countries, or both. It is important to note that clustering search engine 530 may be a Web search engine or a search engine for non-Web content.

Clustering search engine 530 clusters the search result set into categories to form clusters 1-n 532, which represent a clustered result set. These clusters form a taxonomy of categories. Consider for example, a search of the term “mercury.” The results could include hits related to the element, the automobile manufacturer, the record label, the Roman god, the NASA manned spaceflight project, or some other category. In this example, the categories may be “automobiles,” “environment,” “planets,” “music,” and “mythology.”

While these categories are more useful than a seemingly arbitrary list of hits, they are not entirely unambiguous. For example, would a Web page about the NASA manned spaceflight project fall into the “environment” category or the “planets” category? Furthermore, a prior art clustering search engine would simply return the categorized results without taking into consideration the user's intentions. The user would then have to determine which categories are relevant just as he would have to determine which hits are relevant.

In accordance with an illustrative embodiment, clustering search engine 530 classifies the viewed content history that accompanied the search request into the generated taxonomy. If the viewed content history includes URLs of viewed pages, then clustering search engine 530 retrieves the pages before classifying them. By doing this, clustering search engine 530 may then determine which cluster best fits the intentions of the user based on the user's currently viewed page or viewed content history. If the viewed content history that accompanied the search request includes more than one page or the viewed content history fits into more than one category, then the clusters may be ranked in descending order of the number of documents from the history that fit into each category to form ranked cluster result set 534.

As an example, if the viewed content history includes only the currently viewed page, then the cluster in which the currently viewed page fits is ranked first, before any of the other clusters. As a further example, consider a viewed content history that includes ten viewed pages where four pages fit into cluster #2, three pages fit into cluster #1, two pages fit into cluster #3, and one page fits into cluster #5. In this example, clustering search engine 530 would rank the clusters as #2, #1, #3, #5, and then the remaining clusters. Ranked clusters 534 are then returned to the requesting browser 510. Ranked clusters 534 may be returned as a structured document, such as an extensible markup language (XML) or multipurpose Internet mail extension (MIME) search result set, for example.

Turning to FIG. 5B, operation of a clustering search engine is depicted in accordance with one exemplary embodiment. In this embodiment, clustering search engine 560 receives search 552 and viewed content history 554. Clustering search engine 560 may be clustering search engine 530 in FIG. 5A, for example. Clustering search engine 560 receives search 552 at search component 562.

As described above, clustering search engine 560 may be a metasearch engine, which combines searches from multiple search engines 572, 574, and 576. In this case, clustering search engine 560 may be a search front end rather than an actual search engine. As a search front end, clustering search engine 560 obtains a search result set by sending a search request to search engines 572, 574, and 576. While three search engines are shown, any number of search engines may be used depending on the implementation. However, in an alternative embodiment, search component 562 may itself be a search engine. Search component 562 then sends the search result set to clustering component 564. Clustering component 564 clusters the search result set into categories to form clusters.

Disambiguation component 566 receives viewed content history 554 and provides the viewed content history as a disambiguation result set. Clustering component 564 then classifies the disambiguation result set and ranks the categories. Disambiguation component 566 then returns ranked cluster result set 556 to the requesting user.

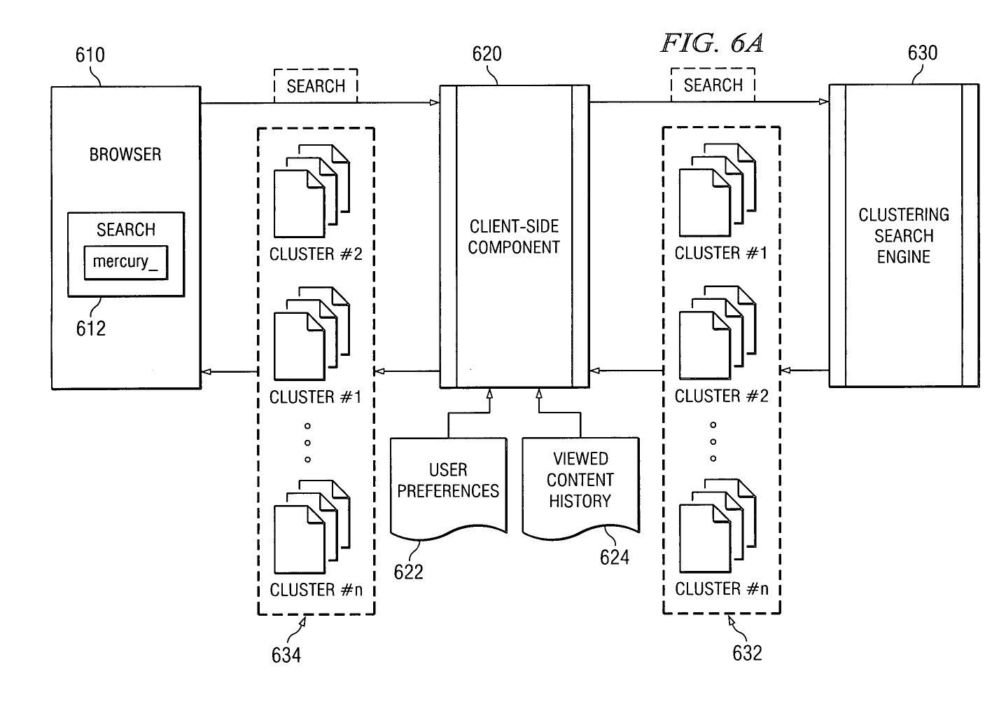

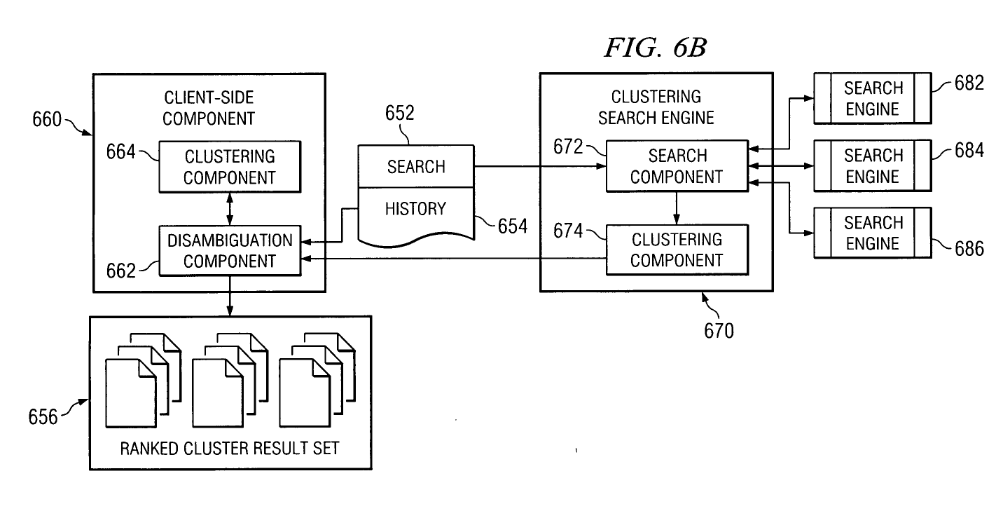

FIGS. 6A and 6B is a block diagram illustrating operation of a clustering search system with client side search disambiguation in accordance with an illustrative embodiment. With reference to FIG. 6A, at the client, browser 610 receives search query 612 from a user. In the depicted example, client-side component 620 sends the search query to clustering search engine 630. Clustering search engine 630 receives the search query and performs the search to obtain search results. It is important to note that clustering search engine 630 may be a Web search engine or a search engine for non-Web content.

Clustering search engine 630 clusters the results into categories to form clusters 1-n 632. These clusters form a taxonomy of categories. Clustering search engine 630 returns clustered search result set 632 to client-side component 620. Search result set 632 may be returned as a structured document, such as an extensible markup language (XML) or multipurpose Internet mail extension (MIME) search result set, for example.

Client-side component 620 may access viewed content history 624, which is maintained by browser 610. The history information may be only the currently viewed page or possibly the entire viewed content history. Also, the history information may include the contents of viewed pages, the title information, or the URLs of the viewed pages, for example. In one exemplary embodiment, the amount of history information and/or the form of the history information to be used for search disambiguation may be set by the user and stored in user preferences 622.

Client-side component 620 may be a component of browser 610. In an alternative embodiment, client-side component 620-may be an extension of browser 610, i.e. a browser plug-in. Alternatively, client-side component 620 may be a software component within a search engine Web page, such as a Java™ applet or the like, or an application that is external to browser 610. For example, in one alternative embodiment, client-side component 620 is a proxy server.

In accordance with an illustrative embodiment, client-side component 620 classifies the viewed content history into the generated taxonomy within clusters 632. If the viewed content history includes URLs of viewed pages, then client-side component 620 retrieves the pages before classifying them. By doing this, client-side component 620 may then determine which cluster best fits the intentions of the user based on the user's currently viewed page or viewed content history. If the viewed content history that accompanied the search request includes more than one page or the viewed content history fits into more than one category, then the clusters may be ranked in descending order of the number of documents from the history that fit into each category to form ranked cluster result set 634. Ranked cluster result set 634 is then returned to the requesting browser 610.

Turning to FIG. 6B, operation of a client-side component, in cooperation with a clustering search engine, is depicted in accordance with one exemplary embodiment. In this embodiment, clustering search engine 670 receives search 652. Clustering search engine 670 may be clustering search engine 630 in FIG. 6A, for example. Clustering search engine 670 receives search 652 at search component 672. Search 652 may be sent directly to clustering search engine 670 or may be forwarded by client-side component 660.

As described above, clustering search engine 670 may be a metasearch engine, which combines searches from multiple search engines 682, 684, and 686. In this case, clustering search engine 670 may be a search front end rather than an actual search engine. As a search front end, clustering search engine 670 obtains a search result set by sending a search request to search engines 682, 684, and 686. While three search engines are shown, any number of search engines may be used depending on the implementation. However, in an alternative embodiment, search component 672 may itself be a search engine. Search component 672 then sends the search result set to clustering component 674. Clustering component 674 clusters the search result set into categories to form clusters and returns the clustered result set to disambiguation component 662 in client-side component 660.

Disambiguation component 662 receives viewed content history 654 and provides the viewed content history as a disambiguation result set to clustering component 664 of client-side component 660. Clustering component 664 may be similar in function to clustering component 674 or clustering component 564 in FIG. 5B. Clustering component 664 then classifies the disambiguation result set and ranks the categories. Disambiguation component 662 then returns ranked cluster result set 656 to the requesting user.

FIG. 7 illustrates an example Web browser display presenting a results page in accordance with an exemplary embodiment. Browser window 700 includes a display area that presents a results page that is received responsive to submitting a search query and receiving clustered search results that are disambiguated based on browser history. In the depicted example, the results page includes categories portion 702 and hits portion 704. Categories portion 702 presents the categories in descending order of relevancy to the viewed content history. Hits portion 704 presents the hits, represented here as links to matching Web documents, with the most relevant category listed first.

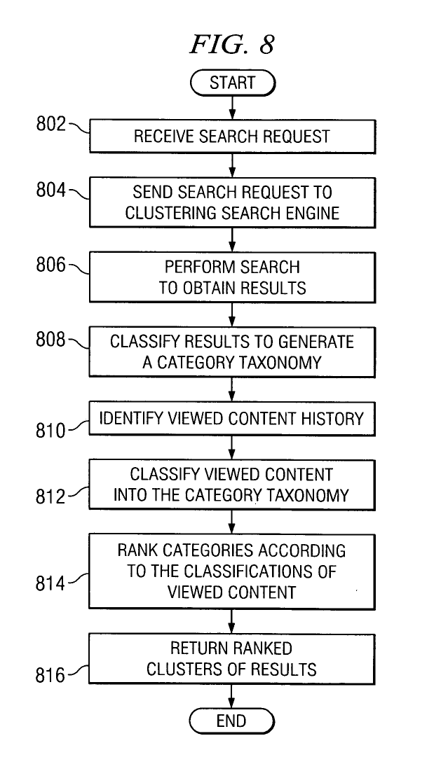

FIG. 8 is a flowchart illustrating operation of a clustering search system with search disambiguation in accordance with an exemplary embodiment. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions that execute on the processor or other programmable data processing apparatus create means for implementing the functions specified in the flowchart block or blocks. These computer program instructions may also be stored in a computer-readable memory, storage medium, or transmission medium that can direct a processor or other programmable data processing apparatus to function in a particular manner, such that the instructions stored in the computer-readable memory, storage medium, or transmission medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

More particularly, with reference to FIG. 8, Operation begins and a client component receives a search request (block 802) and sends the search request to a clustering search engine (block 804). The clustering search engine performs a search to obtain results (block 806) and classifies the results to generate a category taxonomy (block 808).

A cluster ranking component identifies a viewed content history (block 810) and classifies the viewed content history into the category taxonomy (block 812). As described above, the cluster ranking component may be a client-side software component, such as a Web browser component, a browser plug-in, or a stand-alone software application. Alternatively, the cluster ranking component may be a component of the clustering search engine. Next, the cluster ranking component ranks the categories according to the classifications of the viewed content history (block 814). Thereafter, the ranked clusters of results are returned to the requesting user (block 816) and operation ends.

Thus, the illustrative embodiments solve the disadvantages of the prior art by providing a mechanism for context based search disambiguation. A client provides additional cues for search term disambiguation through the context of the specific user's browser. In one embodiment, a viewed content history is sent along with the search term(s) to be disambiguated. The viewed content history acts as a cue to a clustering search engine to display as more relevant the results that are classified in the same category as the pages sent along with the search term(s).

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer program product comprising a computer useable medium having a computer readable program, wherein the computer readable program, when executed on a computing device, causes the computing device to:
obtain a search result set comprising a plurality of data elements that satisfy a search query;
classify the search result set to generate a clustered result set, wherein the clustered result set comprises the plurality of data elements clustered into a plurality of categories;
classify a viewed content history into the plurality of categories; and
rank the clustered result set according to the classification of the viewed content history to form a ranked cluster result set.

2. The computer program product of claim 1, wherein the computer readable program further causes the computing device to:
return the ranked cluster result set to the requesting user.

3. The computer program product of claim 2, wherein the ranked cluster result set is returned to the requesting user as a structured document.

4. The computer program product of claim 1, wherein the computer readable program further causes the computing device to:
present the ranked cluster result set to the requesting user in descending order of the number of data elements from the viewed content history that fit into each of the plurality of categories.

5. The computer program product of claim 1, wherein the viewed content history comprises a currently viewed data element.

6. The computer program product of claim 1, wherein the viewed content history comprises at least a portion of a browser history.

7. The computer program product of claim 1, wherein the computer readable program is a browser extension.

8. The computer program product of claim 1, wherein the computer readable program is a proxy server.

9. The computer program product of claim 1, wherein the computer readable program is a search engine front end.

10. An apparatus, comprising:
a processor; and
a memory coupled to the processor, wherein the memory contains instructions which, when executed by the processor, cause the processor to execute a search disambiguation component to:
obtain a search result set comprising a plurality of data elements that satisfy a search query;
classify the search result set to generate a clustered result set, wherein the clustered result set comprises the plurality of data elements clustered into a plurality of categories;
classify a viewed content history into the plurality of categories; and
rank the clustered result set according to the classification of the viewed content history to form a ranked cluster result set.

11. The apparatus of claim 10, wherein the search disambiguation component is a browser plug-in.

12. The apparatus of claim 10, wherein the search disambiguation component is a proxy server.

13. The apparatus of claim 10, wherein the search disambiguation component is a search engine front end.

14. The apparatus of claim 10, wherein the viewed content history comprises at least a portion of a browser history.

15. A method, in a data processing system, for search disambiguation, the method comprising:
receiving a search query from a requesting user;
obtaining a search result set comprising a plurality of data elements that satisfy the search query;
classifying the search result set to generate a clustered result set, wherein the clustered result set comprises the plurality of data elements clustered into a plurality of categories;
classifying a viewed content history into the plurality of categories; and
ranking the clustered result set according to the classification of the viewed content history to form a ranked cluster result set.

16. The method of claim 15, further comprising:
returning the ranked cluster result set to the requesting user.

17. The method of claim 16, wherein the ranked cluster result set is returned to the requesting user as a structured document.

18. The method of claim 15, further comprising:
presenting the ranked cluster result set to the requesting user in descending order of the number of data elements from the viewed content history that fit into each of the plurality of categories.

19. The method of claim 15, wherein the viewed content history comprises a currently viewed data element.

20. The method of claim 15, wherein the viewed content history comprises at least a portion of a browser history.
